(19) United States
(12) Patent Application Publication
(10) Pub. No.: US 2002/0014297 A1
(43) Pub. Date: Feb. 7, 2002

(54) Process for the manufacturing of an improved decorative laminate and a decorative laminate obtained by the process

(76) Inventors: Laurence Mott, Trelleborg (SE); Roger Hwatz, Grabo (SE)

Correspondence Address: STEVENS, DAVIS, MILLER & MOSHER, L.L.P., Suite 850, 1615 L Street, N.W., Washington, DC, 20036, US

(21) Appl. No.: 09/902,488

(22) Filed: Jul. 11, 2001

Related U.S. Application Data
(60) Provisional application No. 60/217,015, filed on Jul. 11, 2000.

(51) Int. Cl. B32B 5/18; B32B 31/00

(52) U.S. Cl. 156/78; 264/46.4; 264/162; 264/219; 156/230; 427/496; 427/508; 427/385.5; 156/277; 156/242

(57) ABSTRACT

A process for the manufacturing of floor elements, which floor elements comprise an upper decorative surface and a lower surface, edges intended for joining and a core forming a carrying structure. A mixture of polyols, such as polyester or polyether, crude methylene diphenyl diisocyanate and possibly a small amount of blowing agent in a ratio forming a polymeric resin with a density in the range 600-1400 kg/m³ is injected or cast into a mold, whereby a slightly porous or solid polyurethane core is formed. The polurethane core is, possibly after surface treatment such as sanding, provided with an upper decorative surface and possibly a lower counter surface

### CROSS-REFERENCE TO RELATED APPLICATIONS

This application claims the benefit of provisional application serial No. 60/217,015, filed Jul. 11, 2000, the entire disclosure of which is herein incorporated by reference.

### BACKGROUND OF THE INVENTION

1. Field of the Invention

A process for the manufacturing of an improved decorative laminate and a decorative laminate obtained by the process.

The present invention relates to a process for manufacturing a decorative laminate and a decorative laminate obtained by the process.

2. Description of the Related Art

Products clad with thermosetting laminates are quite common nowadays. They are most often used where the demand for abrasion resistance is great but also where resistance towards different chemical substances and moisture is required. Floors, floor skirtings, work tops, table tops, doors and wall panels can serve as an example of such products. The thermosetting laminate is most often made from a number of base sheets and a decorative sheet placed closest to the surface. The decorative sheet may be provided with the desired decor or pattern. Thicker laminates are often provided with a core of particle board or fibre board where both sides are covered with sheets of thermosetting laminate. The outermost sheet is, on at least one side, most often a decorative sheet.

One problem with such thicker laminates is that the core is much softer than the surface layer which is made from paper impregnated with thermosetting resin. This will cause a considerably reduced resistance towards thrusts and blows compared to a laminate with a corresponding thickness made of paper impregnated with thermosetting resin only.

Another problem with thicker laminates with a core of particle board or fibre board is that these normally will absorb a large amount of moisture, which will cause them to expand and soften whereby the laminate will warp. The surface layer might even, partly or completely come off in extreme cases since the core will expand more than the surface layer. This type of laminate can therefore not be used in humid areas, such as bath rooms or kitchens, without problem.

The problems can be partly solved by making the core of paper impregnated with thermosetting resin as well. Such a laminate is most often called compact laminate. These compact laminates are, however, very expensive and laborious to obtain as several tens of layers of paper have to be impregnated, dried and put in layers. The direction of the fibre in the paper does furthermore cause a moisture and temperature difference relating expansion. This expansion is two to three times as high in the direction crossing the fibre than along the fibre. The longitudinal direction of the fibre is coinciding with the longitudinal direction of the paper. One will furthermore be restricted to use cellulose as a base in the manufacturing though other materials could prove suitable.

### SUMMARY OF THE INVENTION

The above problems have through the present invention been solved whereby a flexible process for the manufacturing of a mainly isometric laminate has been achieved where floor elements with radically improved impact resistance, rigidity, moisture resistance is achieved. Accordingly the invention relates to a process for the manufacturing of floor elements, which floor elements comprises an upper decorative surface a lower surface, edges intended for joining and a core forming a carrying structure. The invention is characterised in that;

i) A mixture of polyols, such as polyester or polyether, crude methylene diphenyl diisocyanate and possibly a small amount of blowing agent in a ratio forming a polymeric resin with a density in the range 600-1400 kg/m³ is injected or cast into the mold. A slightly porous or solid polyurethane core to a floor element is hereby formed.

ii) The polurethane core is, possibly after surface treatment such as sanding, provided with an upper decorative surface and possibly a lower counter surface.

The mixture forming the core is preferably containing a flame retardant comprising halogens such as tri-chlorophosphate.

### DETAILED DESCRIPTION OF THE PREFERRED EMBODIMENTS

The mold used for the molding of the polyurethane core is preferably provided with ridges, cores, recesses, protrutions and the like along the edges which ridges, cores, recesses, protrution and the like gives shape to joining members along the edges of the core. The joining members are possibly fine tuned by means of a milling operation after the molding. This fine tuning may incorporate milling of geometries that are difficult to obtain in a moulding process. Among such geometries can be mentioned a single or double sided undercut in a groove. It may also show necessary to trim the edges in order to obtain a snug fit between the floor elements. It is also possible to provide the core with joining members by means of a milling operation after the molding. The mold is suitably also provided with surface embossing providing at least the upper decorative surface with a desired surface structure.

Suitable isocyanate-reactive compounds to be used in the process of the present invention include any of those known in the art for the preparation of rigid polyurethane or urethane-modified polyisocyanurate foams. Of particular importance for the preparation of rigid foams are polyols and polyol mixtures having average hydroxyl numbers of from 100 to 1000, especially from 100 to 700 mg KOH/g, and hydroxyl functionalities of from 2 to 8, especially from 3 to 8. Suitable polyols have been fully described in the prior art and include reaction products of alkylene oxides, for example ethylene oxide and/or propylene oxide, with initiators containing from 2 to 8 active hydrogen atoms per molecule. Suitable initiators include: polyols, for example glycerol, trimethylolpropane, triethanolamine, pentaerythritol, sorbitol and sucrose; polyamines, for example ethylene diamine, tolylene diamine (TDA), diaminodiphenylmethane (DADPM) and polymethylene polyphenylene polyamines; and aminoalcohols, for example ethanolamine and diethanolamine, and mixtures of such initiators. Other suitable polymeric polyols include polyesters obtained by the condensation of appropriate proportions of glycols and higher functionality polyols with dicarboxylic or polycarboxylic acids. Still further suitable polymeric polyols include hydroxyl terminated polythioethers, polyamides, polyesteramides, polycarbonates, polyacetals, polyolefins and polysiloxanes.

Suitable organic polyisocyanates for use in the process of the present invention include any of those known in the art for the preparation of rigid polyurethane or urethane-modified polyisocyanurate foams, and in particular the aromatic polyisocyanates such as diphenylmethane diisocyanate in the form of its 2,4′, 2,2, and 4,4′ isomers and mixtures thereof, the mixtures of diphenylmethane diisocyanates (MDI) and oligomers thereof known in the art as “crude” or polymeric MDI (polymethylene polyphenylene polylsocyanates) having an isocyanate functionality of greater than 2, toluene diisocyanate in the form of its 2,4 and 2,6 isomers and mixtures thereof, 1,5 naphthalene diisocyanate and 1,4 diisocyanatobenzene. Other organic polyisocyanates which may be mentioned include the aliphatic diisocyanates such as isophorone diisocyanate, 1,6 diisocyanatohexane and 4,4′ diisocyanato-dicyclohexylmethane, rigid polyurethane or urethane-modified polyisocyanurate foam to be produced and will be readily determined by those skilled in the art.

The water captured in the raw materials (especially the polyols) can be used as blowing agent, when properly monitored. Otherwise, the polyol stream needs to be desiccated before micro-dosing a blowing agent commonly used. Blowing agents proposed in the prior art include hydrochlorofluorocarbons, hydrofluorocarbons and especially hydrocarbons namely alkanes and cycloalkanes such as isobutane, n-pentane, isopentane, cyclopentane and mixtures thereof as well as water or any other carbon dioxide-evolving compounds.

In addition to the polyisocyanate and polyfunctional isocyanate-reactive compositions and the blowing agent mixture, the foam-forming reaction mixture will commonly contain one or more other auxiliaries or additives conventional to formulations for the production of rigid polyurethane and urethane-modified polyisocyanurate foams. Such optional additives include crosslinking agents, for example low molecular weight polyols such as triethanolamine, foam-stabilising agents or surfactants, for example siloxane-oxyalkylene copolymers, urethane catalysts, for example tin compounds such as stannous octoate or dibutyltin dilaurate or tertiary amines such as dimethylcyclohexylamine or triethylene diamine, isocyanurate catalysts, fire retardants, for example halogenated alkyl phosphates such as tris chloropropyl phosphate, color pigmentation and fillers such as carbon black.

It is also possible to adapt the mechanical properties of the material by adding other materials such as particles or fibre. These type of additives can be used for a number of reasons. Additives may be used to alter adjust or improve acoustic properties, density, thermal coefficient of expansion, thermal conductivity, flexibility, rigidity and brittleness. A proper filler may also reduce the manufacturing costs. Typical particle fillers are minerals such as mica, glass beads and lime, while common fibre fillers are glass, carbon, steel, aramide and cellulose fibres.

According to an embodiment of the invention the first surface webs, constituting a decorative upper surface, is manufactured by laminating at least one uppermost so-called overlay web of melamine-formaldehyde resin impregnated α-cellulose paper with at least one decorative web of decorated melamine-formaldehyde resin impregnated α-cellulose paper and possibly a group of support webs under heat and pressure.

According to an embodiment of the invention, the decorative upper surface, is manufactured by laminating at least one uppermost so-called overlay web of melamine-formaldehyde resin impregnated α-cellulose paper with at least one decorative web of decorated melamine-formaldehyde resin impregnated α-cellulose paper and possibly a group of support webs under heat and pressure so that the resin cures at least partially and the webs are bonded to one another, possibly while being pressed towards a polyurethane core. It is also possible to glue the decorative upper surface on the core. In this case it might show necessary to perform a milling operation of the edges after having applied the decorative upper surface. Support layer webs suitably form a part of the decorative upper surface. The group of support layer webs comprises one or more monochromatic webs of α-cellulose impregnated with melamine-formadehyde resin and/or one or more Kraft-paper webs impregnated with phenol-formaldehyde resin, urea-formaldehyde resin, melamine-formaldehyde resin or combinations thereof. In order to improve the abrasion resistance the overlay webs and optionally the decorative paper webs preferably includes 2-100 g/m² per layer of hard particles of α-aluminum oxide, silicon carbide or silicon oxide having an average particle size in the range 50 nm-150 μm. The scratch resistance is preferably improved by sprinkling 2-100 g/m² of hard particles of α-aluminum oxide, silicon carbide or silicon oxide having an average particle size in the range 50 nni-30 μm on the upper surface of the uppermost overlay web. The decorative upper surface is laminated and at least partially cured prior to the part of the process where the core is achieved and bonded to the decorative upper surface.

According to another embodiment of the invention the decorative upper surface comprises by a printed foil. The printed foil is suitably made of α-cellulose impregnated with a polymeric lacquer or resin such as melamine-formaldehyde, urea-formaldehyde acrylic, maleamid, polyurethane or the like. The printed foil may also be made of a polymer such as polyvinyl-chloride, polyester, polypropylene, polyethylene, polyurethane, acrylic or the like. The upper surface is preferably coated with one or more wear-resistant layers of acrylic or maleamid lacquer on top of the printed foil. The lacquer is suitably of an UV- or electron-beam curing type.

The lacquer is suitably applied in two or more layers with intermediate stages of partial or complete curing. In order to further increase the abrasion resistance the lacquer preferably includes 2-100 g/m² per layer of hard particles of α-aluminum oxide, silicon carbide or silicon oxide having an average particle size in the range 50 nm-150 μm. In order to improve the scratch resistance, 2-100 g/m² of hard particles of α-aluminum oxide, silicon carbide or silicon oxide having an average particle size in the range 50 nm-30 μm is sprinkled on the upper surface of the uppermost layer of lacquer.

According to yet another embodiment of the invention the decorative upper surface comprises a translucent or semi-translucent layer and that particles with sizes in the range 0.5-10 mm are applied together with the polymeric resin. The particles preferably deviate in color from the polymeric resin. It is also possible to include pigmentation in the polymeric resin. The semi-translucent layer is preferably constituted of a sheet which is provided with a printed decor. The printed decor is possibly semi-translucent but can also be opaque, covering only parts of the surface of the sheet. This will give depth to the decor. The semi-translucent foil or web is preferably constituted of α-cellulose impregnated with a polymeric resin or lacquer such as melamine-formaldehyde, urea-formaldehyde, polyurethane, acrylic or maleamide. The semi-translucent sheet may also be constituted of a polymer such as polyvinyl-chloride, acrylic, polyester, polypropylene, polyethylene, polyurethane or the like. The wear resistance is preferably improved by applying a wear layer or a number of wear layers on top of the decor layer. The wear layers are preferably constituted of α-cellulose impregnated with a polymeric resin or lacquer such as melamine-formaldehyde, urea-formaldehyde, polyurethane, acrylic or maleamid. The wear layers may also be constituted of a lacquer such as acrylic or maleamide, possibly of a UV- or electron-beam curing type. Such a lacquer is then preferably applied in two or more layers with intemediate stages of partial or complete curing. In order to further improve the abrasion resistance the wear layers includes 2-100 g/m² per layer of hard particles of α-aluminum oxide, silicon carbide or silicon oxide having an average particle size in the range 50 nm-150 μm. In order to improve the scratch resistance the upper surface of the uppermost of the wear layers contains 2-100 g/m² of hard particles of α-aluminum oxide, silicon carbide or silicon oxide having an average particle size in the range 50 nm-30 μm are applied.

According to yet another embodiment of the invention a decor is applied on the side of the core. The decor is printed directly on the surface or applied on the surface via transfer printing. In order to protect the decor, a wear layer or a number of wear layers are preferably applied on top of the decor. These wear layers are suitably constituted of α-cellulose impregnated with a polymeric resin or lacquer such as melamine-formaldehyde, urea-formaldehyde, polyurethane, acrylic or maleamid. The wear layers are alternativelly constituted of a lacquer such as acrylic or maleamide, possibly of a UV- or electron-beam curing type. A lacquer is preferably applied in two or more layers with intermediate stages of partial or complete curing. In order to improve the abraision resistance the wear layers preferably includes 2-100 g/m² per layer of hard particles of α-aluminum oxide, silicon carbide or silicon oxide having an average particle size in the range 50 nm-150 μm. In order to improve the scratch resistance, 2-100 g/m² of hard particles of α-aluminum oxide, silicon carbide or silicon oxide having an average particle size in the range 50 nm-30 μm is sprinkled on the upper surface of the uppermost layer of lacquer.

We claim:

1. A process for the manufacturing of floor elements, which floor elements comprise an upper decorative surface and a lower surface, edges intended for joining the elements together into a floor and a core forming a carrying structure, comprising:
i) forming a mixture of polyols and, optionally, a small amount of blowing agent in a ratio forming a polymeric resin with a density in the range 600-1400 kg/m³ and injecting or casting the mixture into a mold, whereby a slightly porous or solid polyurethane core is formed, and, thereafter
ii) providing the polurethane core, optionally after surface treatment such as sanding, with an upper decorative surface.

2. A process according to claim 1, including adding a flame retardant to the mixture forming the core.

3. A process according to claim 1, wherein the mold is provided with at least one structure selected from the group consisting of ridges, cores, recesses, and protrusions along the edges, which ridges, cores, recesses, and protrusion give shape to at lest partially form joining members along the edges of the core.

4. A process according to claim 3, including the step of fine tuning the joining members by a milling operation after the molding.

5. A process according to claim 1, wherein the mold is provided with surface embossing providing at least the upper decorative surface with a desired surface structure.

6. A process according to claim 1, including milling the core to provide the core with joining members after the molding.

7. A process according to claim 1, wherein the decorative upper surface is manufactured by laminating at least one uppermost so-called overlay web of melamine-formaldehyde resin impregnated α-cellulose paper with at least one decorative web of decorated melamine-formaldehyde resin impregnated α-cellulose paper and optionally a group of support webs under heat and pressure so that the resin cures at least partially and the webs are bonded to one another.

8. A process according to claim 7, wherein the support layer webs which form a part of the decorative upper surface comprise one or more monochromatic webs of α-cellulose impregnated with melamine-formadehyde resin and/or one or more Kraft-paper webs impregnated with phenol-formaldehyde resin, urea-formaldehyde resin, melamine-formaldehyde resin or combinations thereof.

9. A process according to claim 7, wherein the overlay webs and optionally the decorative paper webs includes 2-100 g/m² per layer of hard particles of α-aluminum oxide, silicon carbide or silicon oxide having an average particle size in the range 50 nm-150 μm.

10. A process according to claim 9, wherein the upper surface of the uppermost overlay web contains 2-100 g/m² of hard particles of α-aluminum oxide, silicon carbide or silicon oxide having an average particle size in the range 50 nm-30 μm.

11. A process according to claim 7, including laminating and at least partially curing the decorative upper surface prior to the part of the process where the core is achieved and bonded to the decorative upper surface.

12. A process according to claim 1, wherein the decorative upper surface comprises a printed foil.

13. A process according to claim 12, wherein the printed foil is made of α-cellulose impregnated with a polymeric lacquer or resin selected from the group consisting of melamine-formaldehyde, urea-formaldehyde acrylic, maleamid, polyurethane and mixtures thereof.

14. A process according to claim 12, wherein the printed foil is made of a polymer selected from the group consisting of polyvinyl-chloride, polyester, polypropylene, polyethylene, polyurethane, acrylic and mixtures thereof.

15. A process according to claim 12, including coating the upper surface with one or more wear-resistant layers of acrylic or maleamid lacquer on top of the printed foil.

16. A process according to claim 15, including the step of exposing the lacquer to an UV- or electron-beam radiation to cure the lacquer.

17. A process according to claim 15, including the step of applying the lacquer in two or more layers with intermediate stages of partial or complete curing.

18. A process according to claim 15, wherein the lacquer includes 2-100 g/m² per layer of hard particles of α-aluminum oxide, silicon carbide or silicon oxide having an average particle size in the range 50 nm-150 μm.

19. A process according to claim 18, wherein the upper surface of the uppermost layer of lacquer contains 2-100 g/m² of hard particles of α-aluminum oxide, silicon carbide or silicon oxide having an average particle size in the range 50 nm-30 μm.

20. A process according to claim 1, wherein the upper decorative surface comprises a translucent or semi-translucent layer and that particles with sizes in the range 0.5-10 mm are applied together with the polymeric resin.

21. A process according to claim 20, wherein the particles deviate in color from the polymeric resin.

22. A process according to claim 20, wherein the polymeric resin also comprises pigmentation.

23. A process according to claim 20, wherein the semi-translucent layer is constituted of a sheet which is provided with a printed decor.

24. A process according to claim 23, wherein the printed decor is semi-translucent.

25. A process according to claim 23, wherein the printed decor is opaque, covering only parts of the surface of the sheet.

26. A process according to claim 20, wherein the semi-translucent layer is constituted of α-cellulose impregnated with a polymeric resin or lacquer selected from the group consisting of melamine-formaldehyde, urea-formaldehyde, polyurethane, acrylic and maleamide.

27. A process according to claim 20, wherein the semi-translucent layer is constituted of a polymer selected from the group consisting of polyvinyl-chloride acrylic, polyester, polypropylene, polyethylene, polyurethane and mixtures thereof.

28. A process according to claim 20, including applying a wear layer or a number of wear layers on top of the sheet.

29. A process according to claim 28, wherein the wear layers are constituted of α-cellulose impregnated with a polymeric resin or lacquer selected from the group consisting of melamine-formaldehyde, urea-formaldehyde, polyurethane, acrylic and maleamid.

30. A process according to claim 28, wherein the wear layers are constituted of a lacquer selected from the group consisting of acrylic and maleamide.

31. A process according to claim 29, including applying the lacquer in two or more layers with intermediate stages of partial or complete curing.

32. A process according to claim 28, wherein the wear layer includes 2-100 g/m² per layer of hard particles of α-aluminum oxide, silicon carbide or silicon oxide having an average particle size in the range 50 nm-150 μm.

33. A process according to claim 32, wherein the upper surface of the uppermost layer contains 2-100 g/m² of hard particles of α-aluminum oxide, silicon carbide or silicon oxide having an average particle size in the range 50 nm-30 μm.

34. A process according to claim 1, including applying a decor on the upper side of the core.

35. A process according to claim 34, including applying a wear layer or a number of wear layers on top of the decor.

36. A process according to claim 35, wherein the wear layers are constituted of α-cellulose impregnated with a polymeric resin or lacquer selected from the group consisting of melamine-formaldehyde, urea-formaldehyde, polyurethane, acrylic and maleamid.

37. A process according to claim 35, wherein the wear layers are constituted of a lacquer selected from the group consisting of acrylic and maleamide.

38. A process according to claim 36, including applying the lacquer in two or more layers with intermediate stages of partial or complete curing.

39. A process according to claim 35, wherein the lacquer includes 2-100 g/m² per layer of hard particles of α-aluminum oxide, silicon carbide or silicon oxide having an average particle size in the range 50 nm-150 μm.

40. A process according to claim 35, wherein the upper surface of the uppermost layer of lacquer contains 2-100 g/m² of hard particles of α-aluminum oxide, silicon carbide or silicon oxide having an average particle size in the range 50 nm-30 μm.

41. The process according to claim 1, wherein the mixture of polyols is selected from the group consisting of polyester, polyether, and crude diphenyl diisocyanate.

42. The process according to claim 1, including the step of providing a lower counter surface on the core.

43. The process of claim 2, wherein the flame retardant comprises a halogen.

44. The process of claim 2, wherein the flame retardant is trichlorophosphate.

45. The process of claim 7, including the step of bonding the webs to one another while being pressed towards the polyurethane core.

46. The process of claim 30, further including exposing the lacquer to UV- or electron-beam radiation to cure the lacquer.

47. The process according to claim 34, wherein the decor is printed directly on the surface of the upper side of the core.

48. The process according to claim 34, wherein the decor is applied to the surface of the upper side of the core by transfer printing.

49. The process of claim 37, further including exposing the lacquer to UV- or electron-beam radiation to cure the lacquer.
